(19) United States
(12) Patent Application Publication
(10) Pub. No.: US 2015/0061789 A1
(43) Pub. Date: Mar. 5, 2015

(54) WAVEGUIDE PROPAGATION APPARATUS COMPATIBLE WITH HERMETIC PACKAGING

(71) Applicant: ASELSAN ELKTRONIK SANAYI VE TICARET ANONIM SIRKETI, Ankara (TR)

(72) Inventors: Zafer Tanc, Ankara (TR); Eyup Tongel, Ankara (TR); Arda Ozgen, Ankara (TR)

(73) Assignee: ASELSAN ELEKTRONIK SANAYI VE TICARET ANONIM SIRKETI, Ankara (TR)

(21) Appl. No.: 14/382,763

(22) PCT Filed: Jan. 23, 2013
(86) PCT No.: PCT/IB2013/050565

§ 371 Date: Sep. 4, 2014

(30) Foreign Application Priority Data
Mar. 9, 2012 (TR) 2012/02709

(51) Int. Cl. H01P 5/107

(52) U.S. Cl. CPC H01P 5/107
USPC 333/26; 333/248

(57) ABSTRACT

This topic is related to a waveguide propagation apparatus, converting microstrip propagation to waveguide propagation, providing hermeticity on the mounting area, eliminating the cabling component causing degradation on the overall performance, involving at least a microwave module (2), and comprising a combination of a base part (3) and a cover part (4).

### TECHNICAL FIELD

This invention is related to a waveguide propagation apparatus, mounted to a microwave module, converting microstrip propagation to waveguide propagation, and compatible with hermetic packaging.

### PREVIOUS TECHNIQUE

In nowadays existing applications, microstrip propagation can be converted to waveguide propagation over the same mechanical part. The transition is provided by a printed-circuit board, of which part outside the waveguide is a microstrip line, whereas the part inside the waveguide is an inserted probe. However, hermeticity cannot be acquired unless a usage of hermetic window at the opening of the waveguide because the transition between two propagations takes place on the same mechanical part. On the other hand, appending hermetic window increases both complexity and owning cost of the structure.

In another application of the known technique, an adaption of the transition method between coaxial and waveguide propagations is stated. The coaxial connector of this structure and the one of the microwave module are linked via a cabling component; hence, the transition between microstrip and waveguide propagations is achieved in a roundabout way. Despite the hermeticity is attained at the module side, a degradation on the overall performance is inevitable because of the cabling component holding the connection between the transition structure and the microwave module. The cabling component causes an increment on noise figure parameter of the system when placed at the input of the microwave module, whereas a decrement on amplitude of the output power when placed at the output.

Being an application of the known technique, a waveguide-to-microstrip transition module is mentioned in a United States patent document of which number is U.S. Pat. No. 5,202,648 (A). This module transmits electromagnetic energy received between the waveguide and the signal processing circuit. The module consists of a waveguide, a circuit panel and a microstrip line. The microstrip line directed by the waveguide is straightly linked to the signal processing circuit. The system is covered hermetically to surround the circuit panel.

Being an application of the known technique, a waveguide system including a tuning element, an adaptor, a waveguide and pin link elements is mentioned in a United States patent document of which number is U.S. Pat. No. 6,549,106 (B2).

### SHORT DEFINITION OF THE INVENTION

An objective of this invention is to make real a waveguide propagation apparatus, which is mounted to a microwave module having a coaxial connector.

Another objective of this invention is to make real a waveguide propagation apparatus, which is compatible with hermetic packaging.

Another objective of this invention is to make real a waveguide propagation apparatus, which converts microstrip propagation to waveguide propagation.

Another objective of this invention is to make real a waveguide propagation apparatus, which eliminates the cabling component causing degradation on the overall performance.

### DETAILED DEFINITION OF THE INVENTION

In order to succeed in the objectives of this invention, a produced waveguide propagation apparatus is shown in the attached figures, which are:

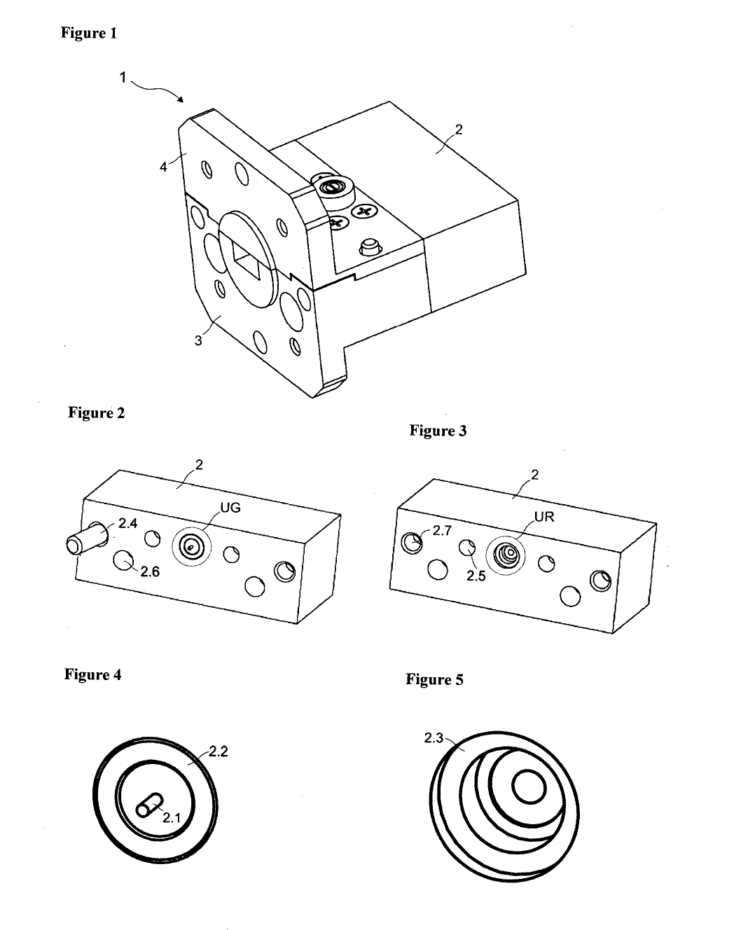

FIG. 1. The perspective view of the waveguide propagation apparatus

FIG. 2. The perspective view of the microwave module

FIG. 3. The perspective view of the microwave module

FIG. 4. The enlarged view of UG area placed in FIG. 2

FIG. 5. The enlarged view of UR area placed in FIG. 3

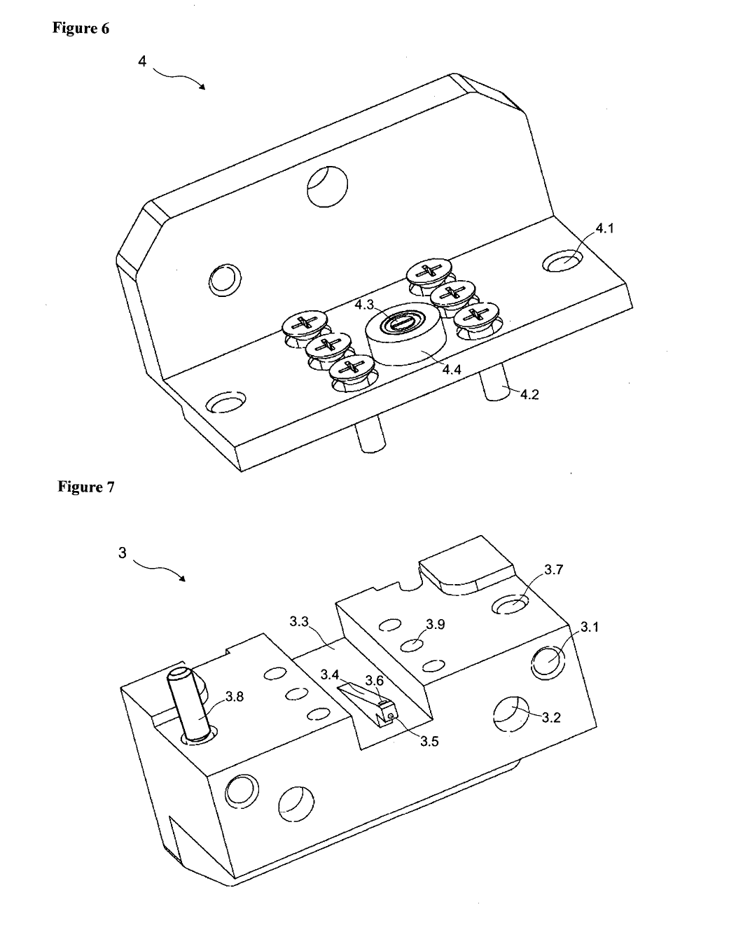

FIG. 6. The perspective view of the cover part

FIG. 7. The perspective view of the base part

Components shown in the figures are enumerated one by one and the denotations of these numbers are given below:
1. Waveguide propagation apparatus
2. Microwave module
   2.1. Conductive pin
   2.2. Solder ring
   2.3. Solder ring detail
   2.4. Module guiding pin
   2.5. Connector mounting detail
   2.6. Module mounting screw detail
   2.7. Module guiding pin detail
3. Base Part
   3.1. Module guiding pin hole
   3.2. Module mounting screw hole
   3.3. Waveguide groove
   3.4. Conductive pin bearing
   3.5. Conductive pin detail
   3.6. Soldering hole
   3.7. Apparatus guiding pin detail
   3.8. Apparatus guiding pin
   3.9. Apparatus mounting screw detail
4. Cover Part
   4.1. Apparatus guiding pin hole
   4.2. Apparatus mounting screw
   4.3. Microwave tuning screw
   4.4. Microwave tuning screw detail

A waveguide propagation apparatus (1), converting microstrip propagation to waveguide propagation, providing hermeticity on the mounting area, and eliminating the cabling component causing degradation on the overall performance, principally consists of,
at least a microwave module (2) transmitting/receiving RF signal,
at least a conductive pin (2.1), installed in the microwave module (2), linked to a microstrip line enabling electromagnetic propagation, and making signal transfer possible from/to the outer surface,
at least a solder ring (2.2), carrying out the mounting of the conductive pin (2.1) to the microwave module (2) by surrounding the conductive pin (2.1) when it is melted, and ensuring hermeticity on the mounting area,
at least a solder ring detail (2.3), bearing the solder ring (2.2), having a definite depth and a diameter larger than the diameter of the solder ring (2.2), and located on the side wall of the microwave module (2),
at least a module guiding pin (2.4) guaranteeing the mounting of the waveguide propagation apparatus (1) to the microwave module (2) in a fixed manner,
at least a connector mounting detail (2.5) providing an attachment of a coaxial connector, by the help of which the functionality of the microwave module (2) is validated before the mounting of the waveguide propagation apparatus (1) to the microwave module (2), by the usage of a screw,
at least a module mounting screw detail (2.6) on the microwave module (2) to mount the waveguide propagation apparatus (1) to the microwave module (2) by the usage of a screw,
at least a module guiding pin detail (2.7), accepting the module guiding pin (2.4), and located on the side wall of the microwave module (2),
at least a base part (3), providing the continuity of the electromagnetic propagation, and mounted to the microwave module (2),
at least a module guiding pin hole (3.1) concentric with the module guiding pin detail (2.7) to make the alignment of the base part (3) with respect to the microwave module (2) by accepting the module guiding pin (2.4),
at least a module mounting screw hole (3.2) concentric with the module mounting screw detail (2.6) to disable any movement of the base part (3) after the mounting to the microwave module (2) by the usage of a screw,
at least a waveguide groove (3.3) aligned with the conductive pin (2.1) when the base part (3) is mounted to the microwave module (2),
at least a conductive pin bearing (3.4), found on the waveguide groove (3.3), and close to the microwave module (2) to maintain the conductive pin (2.1) when the base part (3) is mounted to the microwave module (2),
at least a conductive pin detail (3.5) accepting the conductive pin (2.1),
at least a soldering hole (3.6) to improve the electrical conductivity by soldering the conductive pin (2.1) into the conductive pin detail (3.5),
at least an apparatus guiding pin detail (3.7) located on the upper surface of the base part (3) and the same plane intersecting the waveguide groove (3.3),
at least an apparatus guiding pin (3.8) accepted by the apparatus guiding pin detail (3.7) to make necessary alignments,
at least an apparatus mounting screw detail (3.9) located on the upper surface of the base part (3) and close to the waveguide groove (3.3),
at least a cover part (4) mounted on the base part (3) to constitute the top side of the waveguide groove (3.3),
at least an apparatus guiding pin hole (4.1) concentric with the apparatus guiding pin detail (3.7) to make the alignment of the cover part (4) with respect to the base part (3) by accepting the apparatus guiding pin (3.8),
at least an apparatus mounting screw (4.2) uniting the base part (3) and the cover part (4) by screwing into the apparatus mounting screw detail (3.9),
at least a microwave tuning screw (4.3) minimizing the return and insertion losses of the signal transmitted/received by the conductive pin (2.1),
at least a microwave tuning screw detail (4.4), accepting the microwave tuning screw (4.3), and located on the upper surface of the cover part (4).

In an application of this invention, the conductive pin (2.1) is installed on one of the side walls of the microwave module (2) transmitting/receiving RF signal. The conductive pin (2.1) is linked to a microstrip line which is located in the microwave module (2) and is enabling electromagnetic propagation; hence, the conductive pin (2.1) makes signal transfer possible from/to the outer surface. The mounting of the conductive pin (2.1) to the microwave module (2) is carried out by the solder ring (2.2) which performs this action by surrounding the conductive pin (2.1) when it is melted; moreover, the mentioned action ensures hermeticity to the microwave module (2) on the mounting area. At the time of the mounting of the conductive pin (2.1), the solder ring (2.2) is held in the solder ring detail (2.3) located on the side wall of the microwave module (2). The solder ring detail (2.3) has a definite depth and a diameter larger than the diameter of the solder ring (2.2). The solder ring (2.2) is heated, and then, melted to fix and position the conductive pin (2.1) by surrounding it. After that, the base part (3) is mounted to the microwave module (2). For this process, the conductive pin (2.1) is accepted by the conductive pin detail (3.5) while the module guiding pin (2.4) passes through the module guiding pin hole (3.1) and falls into the module guiding pin detail (2.7). Notice that, the alignment of the base part (3) is procured by the settlement of the module guiding pin (2.4) in the module guiding pin detail (2.7). Afterwards, the electrical conductivity between the conductive pin (2.1) and the conductive pin bearing (3.4) is improved by soldering into the soldering hole (3.6) of the conductive pin bearing (3.4). In order to finish the mounting to the microwave module (2), the base part (3) is screwed into the module mounting screw detail (2.6). Furthermore, the cover part (4) is aligned with respect to the base part (3) by the help of the apparatus guiding pin (3.8). Then, the base part (3) and the cover part (4) are got united by the use of the apparatus mounting screw (4.2), which lets the construction of the waveguide propagation apparatus (1) to the final step: The microwave tuning screw (4.3) minimizes the return and insertion losses of the signal transmitted/received by the conductive pin (2.1).

In another application of this invention, at least a coaxial connector can be attached to the microwave module (2) by screwing into the connector mounting detail (2.5) on the side wall of the microwave module (2). Therefore, the functionality of the microwave module (2) is validated before the mounting of the waveguide propagation apparatus (1) to the microwave module (2).

The above are exemplary applications of carrying out this invention, a waveguide propagation apparatus (1) compatible with hermetic packaging. It is to be understood that the invention is not limited thereto but may be otherwise variously embodied within the scope of the following claims.

1. A waveguide propagation apparatus, converting microstrip propagation to waveguide propagation, providing hermeticity on a mounting area, and
eliminating the cabling component causing degradation on the overall performance, comprising:
at least a microwave module transmitting or receiving RF signal;
at least a conductive pin, installed in the microwave module, linked to a microstrip line enabling electromagnetic propagation, and making signal transfer possible from the outer surface or to the outer surface;
at least a solder ring, carrying out a mounting of the conductive pin to the microwave module by surrounding the conductive pin when it is melted, and ensuring hermeticity on the mounting area;
at least a solder ring detail, bearing the solder ring, having a definite depth and a diameter larger than the diameter of the solder ring, and located on the side wall of the microwave module;
at least a module guiding pin guaranteeing a mounting of the wave tide propagation apparatus to the microwave module in a fixed manner;
at least a connector mounting detail providing an attachment of a coaxial connector, by the help of which the functionality of the microwave module is validated before the mounting of the waveguide propagation apparatus to the microwave module, by the usage of a screw;
at least a module mounting screw detail on the microwave module to mount the waveguide propagation apparatus to the microwave module by the usage of a screw;
at least a module guiding pin detail, accepting the module guiding pin, and located on the side wall of the microwave module;
at least a base part, providing a continuity of the electromagnetic propagation, and mounted to the microwave module;
at least a module guiding pin hole concentric with the module guiding pin detail to make the alignment of the base part with respect to the microwave module by accepting the module guiding pin;
at least a module mounting screw hole concentric with the module mounting screw detail to disable any movement of the base part after the mounting to the microwave module by the usage of a screw;
at least a waveguide groove aligned with the conductive pin when the base part is mounted to the microwave module;
at least a conductive pin bearing found on the waveguide groove, and close to the microwave module to maintain the conductive pin when the base part is mounted to the microwave module;
at least a conductive pin detail accepting the conductive pin;
at least a soldering hole to improve the electrical conductivity by soldering the conductive pin into the conductive pin detail;
at least an apparatus guiding pin detail located on an upper surface of the base part and a same plane intersecting the waveguide groove;
at least an apparatus guiding pin accepted by the apparatus guiding pin detail to make necessary alignments;
at least an apparatus mounting screw detail located on the upper surface of the base part and close to the waveguide groove;
at least a cover part mounted on the base part to constitute the top side of the waveguide groove;
at least an apparatus guiding pin hole concentric with the apparatus guiding pin detail to make the alignment of the cover part with respect to the base part by accepting the apparatus guiding pin;
at least an apparatus mounting screw uniting the base part and the cover part by screwing into the apparatus mounting screw detail;
at least a microwave tuning screw minimizing the return and insertion losses of the signal transmitted or received by the conductive pin;
at least a microwave tuning screw detail, accepting the microwave tuning screw, and located on the upper surface of the cover part.

2. As stated in claim 1, the waveguide propagation apparatus, wherein a conductive pin is installed on the side wall of the microwave module.

3. The waveguide propagation apparatus of claim 1, wherein a solder ring carries out the mounting of the conductive pin, and ensures hermeticity to the microwave module on the mounting area.

4. The waveguide propagation apparatus of claim 1, wherein a solder ring detail bears the solder ring, and is located on the side wall of the microwave module.

5. The waveguide propagation apparatus of claim 1, wherein the module guiding pin detail and the module guiding pin hole are accepting the module guiding pin when the base part is mounted to the microwave module.

6. The waveguide propagation apparatus of claim 1, wherein the soldering hole improves the electrical conductivity by soldering the conductive pin into the conductive pin detail.

7. The waveguide propagation apparatus of claim 1, wherein the apparatus guiding pin aligning the cover part on the base part in a fixed manner.

8. The waveguide propagation apparatus of claim 1, wherein the apparatus mounting screw units the base part and the cover part by screwing into the apparatus mounting screw detail after the cover part is aligned on the base part.

9. The waveguide propagation apparatus of claim 1, wherein the microwave tuning screw minimizes the return and insertion losses of the signal transmitted or received by the conductive pin, and installs into the microwave tuning screw detail.
